(19) United States
(12) Patent Application Publication
(10) Pub. No.: US 2019/0133098 A1
(43) Pub. Date: May 9, 2019

(54) DEVICE FOR PREVENTING FISH HOOK FROM SNAGGING ON BOTTOM

(71) Applicant: Man Heum LEE, Chungju-si (KR)

(72) Inventor: Man Heum LEE, Chungju-si (KR)

(21) Appl. No.: 15/998,623

(22) PCT Filed: Feb. 8, 2017
(86) PCT No.: PCT/KR2017/001348

§ 371 Date: Aug. 16, 2018

(30) Foreign Application Priority Data
Feb. 16, 2016 (KR) 10-2016-0017842

(51) Int. Cl. A01K 85/02; A01K 83/06; A01K 91/04

(52) U.S. Cl. CPC A01K 85/02; A01K 91/04; A01K 83/06

(57) ABSTRACT

The present invention relates to a device for preventing a fish hook from snagging on the bottom, the device comprising: an eye insertion part (100) made from a soft material having an excellent elasticity, such that a hook eye (11) to which a fishing line (20) is tied is inserted therein; a line guide part (110) through which the fishing line (20) passes, and which is made from the same material as that of the eye insertion part (100), maintains, at the upper end of the eye insertion part (100), a state of being bent in an “inverted L” shape and is stretched so as to form a “straight” shape in conjunction with the eye insertion part (100) when a hookset is performed with the fishing line (20); and a snagging prevention piece (200) of which both ends (210) maintain a state, in which the both ends thereof are opened into a “V” shape over the hook point (13) of a fish hook (10) hooked into the eye insertion part (100), at both side surfaces of a front edge part (120) at which the eye insertion part (100) and the line guide part (110) come into contact with each other, and the both ends (210) are rotated toward a hook shank (12) when the line guide part (110) is stretched by a hookset and the like, and thus maximally preventing the loss of fishing tackles since the concern that the hook point is snagged on weeds or bedrocks in water is eliminated by the snagging prevention piece for effectively blocking the side above the hook point, and obtaining a great effect of luring a big fish since, when the snagging prevention piece is formed as a fake bait having the shape of a small fish, a live bait and the fake bait of the fish hook can be used together.

### TECHNICAL FIELD

The present invention relates to a device for preventing a fishing hook from snagging on the bottom and more specifically, to a device for preventing a fishing hook from snagging on the bottom which can particularly prevent a hook point from being snagged on weeds or bedrocks etc. in the water such that fishing is easily done, that the loss of fishing tackles such as a fishing line and a fishing hook is prevented thereby making it possible to prevent environmental pollution and that time spent replacing tackles is significantly reduced, at the time of fishing.

### RELATED ART

In general, a fishing hook is a sort of device most commonly used for fishing.

The fishing hook consists of parts such as a hook eye around which the front end of a fishing line of a fishing rod is wound and tied, a hook shank, a bend, a hook point and a barb protruding from the lower part of the hook point to prevent a fish hooked onto the hook from escaping.

The fishing hook at the front end of the fishing line is cast into water by means of the fishing rod after a bait is hooked onto the point of the fishing hook, and then the fishing hook is sunk into water by means of a lead sinker. Then, a fish is hooked onto the fishing hook when the fish is about to bite the bait hooked onto the fishing hook sunk in water and then, the fishing line is swiftly snatched.

Additionally, the fishing hook hooked onto the mouth of the fish does not escape from the mouth of the fish by means of the barb protruding in a reverse direction such that the fish is drawn from water in a state where the fish is hooked onto the fishing hook.

Further, at the time of fishing, a fishing hook is often drawn out of water not only when a fish bites a bait onto the fishing hook but also when a bait onto the fishing hook that was cast into water is replaced.

There are many obstacles such as various seaweeds or bedrocks etc. in the water. If a fish is hooked onto a fishing hook, the fishing hook is not caught by seaweeds or bedrocks when the fish is drawn out of water because the fishing hook is hooked onto the mouth of the fish.

When a vacant fishing hook is drawn out of water to replace a bait onto the fishing hook, the sharp hook point of the vacant fishing hook is often caught by seaweeds or bedrocks etc. Additionally, when a fishing hook is not rigidly caught by seaweeds or bedrocks, if the fishing line is pulled several times, the fishing hook escapes from the seaweeds or the bedrocks.

However, when a fishing hook is rigidly caught by seaweeds or bedrocks, the fishing hook cannot escape no matter how strongly the fishing line is pulled. Finally, the fishing line has to be cut, and a fishing line, a fishing hook and a lead sinker, a float etc. need to be installed again for fishing. This means a huge loss of fishing tackles.

As a means to solve the above-described problems, Korean Laid-Open Patent Publication No. 10-2010-0071454 (published on Jun. 29, 2010) discloses an invention titled “A FISHINGNEEDLE” (hereinafter referred to as a prior art).

According to the prior art, an insertion hole is formed at the body of a fishing hook, a cover for covering a hook (hook point) at the end of the fishing hook is hinge-coupled to the insertion hole so as to rotate upwards and downwards, support protrusions of the cover protrude from both sides of the insertion hole where the cover is installed such that the hook (hook point) is covered by the cover so as not to be caught by seaweeds or bedrocks.

### PRIOR ART DOCUMENT

### Patent Document

(Patent Document 1) Korean Laid-Open patent Publication No. 10-2010-0071454 (published on Jun. 29, 2010) titled “A FISHINGNEEDLE”

### DETAILED DESCRIPTION OF THE INVENTION

### Technical Field

According to the above-described prior art, an insertion hole is formed at a hook shank that is very thin, and a cover is hinge-coupled to such an insertion hole. The prior art with such a configuration cannot be mass-produced. As a result, the price of the fishing hook goes up thereby putting a financial burden when those who like to fish purchase fishing tackles.

Further, according to the prior art, when the support protrusions for maintaining a state where the cover is lifted upwards wear out or loosen, the cover moves down towards the hook point and covers the hook point all the time in water.

When pulling and biting a bait, a fish is not at all hooked onto the hook point due to the cover that is covering the hook point although the fishing line is strongly snatched If the cover covers the hook point.

As a means to solve the problems with the conventional and prior arts, the present invention is directed to providing a device for preventing a fishing hook from snagging on the bottom, which can particularly prevent a hook point from being snagged on weeds or bedrocks etc. in the water such that fishing is easily done, that the loss of fishing tackles is minimized when a fishing line is pulled to replace a bait.

The present invention is also directed to providing a device for preventing a fishing hook from snagging on the bottom which can function as a fake bait such that a live bait and the fake bait of the fishing hook can be used together thereby maximizing the effect of fishing.

### Technical Solutions

As a means to achieve the above-described aims, a device for preventing a fishing hook from snagging on the bottom includes an eye insertion part which is made from a material that is soft and has excellent elasticity and into which a hook eye to which a fishing line is tied is inserted; a line guide part through which the fishing line passes, which is made from the same material as the eye insertion part, and which maintains, at the upper end of the eye insertion part, a state of being bent in a “¬” shape and then is stretched so as to form a “straight line” shape in conjunction with the eye insertion part when the fishing line is snatched or pulled strongly; and a snagging prevention piece which is installed at both side surfaces of a front edge part at which the eye insertion part and the line guide part come into contact with each other, and whose both ends maintain a state of being opened into a “V” shape over the hook point of a fishing hook 10 hooked onto the eye insertion part and then rotate toward a hook shank when the line guide part is stretched.

The present invention is also directed to providing a device for preventing a fishing hook from snagging on the bottom, in which the snagging prevention piece is formed as a fake bait having the shape of a small fish such that a live bait and the fake bait of the fishing hook can be used together.

### Advantageous Effects

The present invention has the advantage of preventing the loss of fishing tackles as much as possible without causing the hook point of a fishing hook to be caught by weeds or bedrocks in water because a line guide part is pulled while maintaining a state of being bent in a “¬” shape in conjunction with an eye insertion part such that a snagging prevention piece passes while effectively protecting the upper side of the hook point.

Additionally, the present invention also has the advantage of luring a large number of fish because the snagging prevention piece is formed as a fake bait having a shape like a krill (small shrimp) such that a live bait and the fake bait of the fishing hook can be used together.

### BRIEF DESCRIPTION OF THE INVENTION

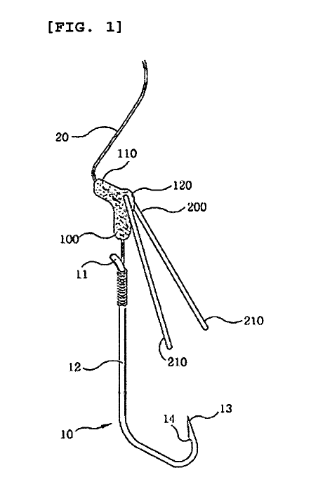

FIG. 1 is a perspective view illustrating a state where a device for preventing a fishing hook from snagging on the bottom of the present invention is separated from a fishing hook.

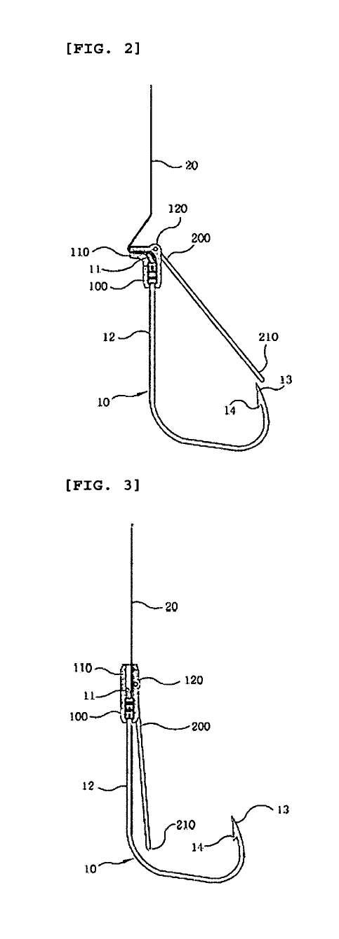

FIG. 2 is a cross sectional view illustrating a state where a device for preventing a fishing hook from snagging on the bottom of the present invention is fitted into a hook eye.

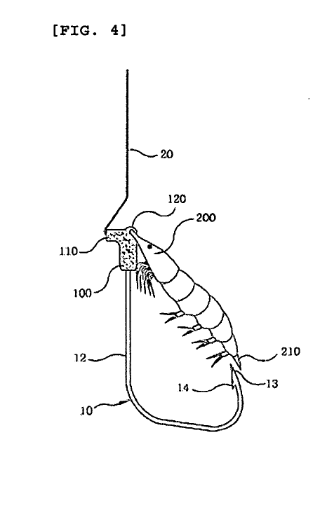

FIG. 3 is a cross sectional view illustrating a state where a snagging prevention piece escapes from a hook point and moves towards a hook shank when a fishing line is snatched in the present invention.

FIG. 4 is a side view illustrating a state where a snagging prevention piece of the present invention is used as a fake bait.

### BEST MODE FOR CARRYING OUT THE INVENTION

Below, technical configurations and operations of the present invention as a means to achieve the above-described purposes will be described in detail with reference to the attached drawings.

FIG. 1 is a perspective view illustrating a state where a device for preventing a fishing hook from snagging on the bottom of the present invention is separated from a fishing hook, FIG. 2 is a cross sectional view illustrating a state where a device for preventing a fishing hook from snagging on the bottom of the present invention is fitted into a hook eye of a fishing hook, and FIG. 3 is a cross sectional view illustrating a state where a snagging prevention piece escapes from a hook point and moves towards a hook shank when a fishing line is snatched tensely in the present invention.

A device for preventing a fishing hook from snagging on the bottom according to the present invention, as described, includes an eye insertion part 100 which is made from a material that is soft and has excellent elasticity, and which has an eye insertion hole therein such that a hook eye 11 to which a fishing line 20 is tied is inserted into the eye insertion part; and a line guide part 110 which has a line guide hole linked with the eye insertion hole such that the fishing line 20 tied to the hook eye 11 passes, which is made from the same material as the eye insertion part 100, and which maintains, at an upper end of the eye insertion part 100, a state of being bent in a “¬” shape and then is stretched so as to form a “straight line” shape in conjunction with the eye insertion part 100 when the fishing line 20 is snatched.

Additionally, a device for preventing a fishing hook from snagging on the bottom further includes a snagging prevention piece 200 whose both ends 210 maintain a state of being opened into a “V” shape over a hook point 13 of a fishing hook 10 hooked onto the eye insertion part 100, at both side surfaces of a front edge part 120 at which the eye insertion part 100 and the line guide part 110 come into contact with each other, and rotate toward a hook shank 12 when the line guide part 110 is stretched.

Herein, the eye insertion part 100 and the line guide part 110 are preferably made from a silicone-based material which is soft and has excellent elasticity, and the snagging prevention piece 200 is preferably made from a soft material having excellent elasticity and resilience. In the drawings, reference numeral 14 that is not described denotes a barb of the fishing hook 10.

At the time of installing a device for preventing a fishing hook from snagging on the bottom of the present invention with such a configuration, as illustrated in FIG. 1, when the front end of the fishing line 20 passes through the line guide part 110 toward the eye insertion part 100, the fishing line 20 is tied to the hook eye 11 of the fishing hook 10, and then, the hook eye 11 to which the fishing line 20 is tied is inserted into the eye insertion part 100, if a hook point 13 is positioned between both ends of the snagging prevention piece 200 that is opened into a “V” shape, a device for preventing a fishing hook from snagging on the bottom of the present invention, as illustrated in FIG. 2, is swiftly and easily installed at the hook eye 11 of the fishing hook 10. Conventional fishing hooks may be used for the present invention.

A device for preventing a fishing hook from snagging on the bottom of the present invention, as illustrated in FIG. 2, is installed, and even when the snagging prevention piece 200 is positioned at the hook point 13, a live bait may be easily hooked by the hook point 13 because both ends of the snagging prevention piece 200, as illustrated in FIG. 1, are spaced apart from each other at a regular interval so as to position the hook point 13 between both ends of the snagging prevention piece.

When a live bait needs to be replaced, a fishing line 20 is gently pulled such that fish are prevented from escaping after a fishing hook 10 onto which a live bait is hooked is cast into the water for fishing.

If the fishing line 20 is gently pulled as described above, the snagging prevention piece 200 protects the upper side of the hook point 13 of the fishing hook 10 which is pulled along the fishing line 20 because the line guide part 110 into which the fishing line 20 is inserted and by which the fishing line 20 is guided is pulled while maintaining a state of being bent in a “¬” shape at the eye insertion part 100.

Then, the snagging prevention piece 200 made from a material having excellent elasticity and resilience first bumps against seaweeds or bedrocks before the barb 14 and the hook point 13 are caught by weeds or bedrocks in the water so as to allow the hook point 13 to pass and to allow the fishing hook 10 to be safely pulled out of the water. Accordingly, a live bait may be swiftly replaced. Further, fishing hooks are often caught by seaweeds or bedrocks at the time of replacing a bait. However, the present invention enables the hook point and barb 14 not to be caught by seaweeds or bedrocks thereby preventing the loss of fishing tackles as much as possible.

Additionally, when a fish bites a live bait hooked onto a fishing hook 10 in the water, a fishing line 20 is rapidly snatched. As described, when a fishing line 20 is pulled through a rapid snatch or through a bite of a huge fish, the soft and elastic line guide part 110 is stretched in the form of a line along the length-wise direction of the eye insertion part 100 by means of the pulling force.

Then, as illustrated in FIG. 3, both ends 210 of the snagging prevention pieces 200 at both sides of the front edge part 120 completely expose the hook point 13 while rotating towards the hook shank 12 such that a fish is hooked easily and safely onto the hook point 13 of the fishing hook 10.

FIG. 4 is a side view illustrating a state where a snagging prevention piece 200 of the present invention is used as a fake bait. As illustrated in FIG. 4, a live bait and the fake bait of the fishing hook can be used together when the snagging prevention piece is formed as a fake bait having the shape of a small fish.

Accordingly, the present invention may function not only as a device for preventing a fishing hook from snagging on the bottom but also as a fish attracting and hooking means such that a large number of fish may be hooked.

[Description of the Symbols]

| | |
|---|---|
| 10: Fishing hook | 11: Hook eye |
| 12: Hook shank | 13: Hook point |
| 14: Barb | 100: Eye insertion part |
| 110: Line guide part | 120: Edge part |
| 200: Snagging prevention piece | 210: Both ends |

1. A device for preventing a fishing hook from snagging on the bottom comprising:
an eye insertion part (100) which is made from a material that is soft and has excellent elasticity and which has an eye insertion hole therein such that a hook eye (11) to which a fishing line (20) is tied is inserted into the eye insertion part;
a line guide part (110) which has a line guide hole linked with the eye insertion hole such that the fishing line (20) tied to the hook eye (11) passes, which is made from the same material as the eye insertion part (100), and which maintains, at an upper end of the eye insertion part (100), a state of being bent in a “¬” shape and then is stretched so as to form a “straight line” shape in conjunction with the eye insertion part (100) when the fishing line (20) is snatched; and
a snagging prevention piece (200) whose both ends (210) maintain a state of being opened into a “V” shape over a hook point (13) of a fishing hook (10) hooked onto the eye insertion part (100), at both side surfaces of a front edge part (120) at which the eye insertion part (100) and the line guide part (110) come into contact with each other and rotate toward a hook shank (12) when the line guide part (110) is stretched.

2. The device for preventing a fishing hook from snagging on the bottom according to claim 1, wherein the eye insertion part (100) and the line guide part (110) are made from a silicone-based material which is soft and has excellent elasticity, and
the snagging prevention piece (200) is made from a soft material having excellent elasticity and resilience.

3. The device for preventing a fishing hook from snagging on the bottom according to claim 1, wherein the snagging prevention piece (200) is formed as a fake bait having a shape like a krill (small shrimp) such that a live bait and the fake bait of the fishing hook can be used together.
